(19) United States
(12) Patent Application Publication
(10) Pub. No.: US 2026/0028851 A1
(43) Pub. Date: Jan. 29, 2026

(54) FLAG POLE DEVICE

(71) Applicant: Thuan Thai Hardware Company Limited, Tan Uyen (VN)

(72) Inventor: He Shui De, Tan Uyen (VN)

(73) Assignee: Thuan Thai Hardware Company Limited, Tan Uyen (VN)

(21) Appl. No.: 18/780,776

(22) Filed: Jul. 23, 2024

(51) Int. Cl. E04H 12/32; E04H 12/22; G09F 17/00

(52) U.S. Cl. CPC E04H 12/32; E04H 12/2269; G09F 17/00; G09F 2017/0058

(57) ABSTRACT

A flag pole device may include a base having a mounting plate and a channel wall forming a pole channel. A first end of an elongated pole may be coupled within the pole channel. A second end of the elongated pole may be coupled to a cap. A fastener ring may be coupled to a flag coupler, and the fastener ring and flag coupler may be coupled to the elongated pole between the base and cap. The flag coupler may include a retainer and a housing. The fastener ring may be coupled to the flag coupler by inserting a retainer wall of the retainer through a major ring aperture of the fastener ring and into a housing channel of the housing so that the fastener ring is positioned between a retainer lip of the retainer and the housing. The fastener ring may comprise a flag fastener that may be coupled to a flag, banner, etc.

### FIELD OF THE INVENTION

This patent specification relates to the field of devices that are configured to position and secure flags, banners, and the like. More specifically, this patent specification relates to a flag pole device that provides improved mounting choices for a flag, banner, or the like and improved structural stability.

### BACKGROUND

Many individuals desire to display flags, banners, and the like to show the individual's political affiliations, sports affiliations, religious affiliations, interests, hobbies, and other information. While some devices exist for mounting flags, banners, and the like to various surfaces and objects, these devices only offer limited mounting and flag orientation capabilities. Additionally, these existing devices are not considered high quality products that are built to last. They are not easy to assemble and frequently loosen and fall apart after being assembled.

Therefore, a need exists for novel devices that are configured to position and secure flags, banners, and the like. A further need exists for novel flag pole devices that provide increased mounting and flag orientation capabilities. There is also a need for novel flag pole devices that are high quality products that are built to last, that are easy to assemble, and that do not loosen or fall apart after being assembled.

### BRIEF SUMMARY OF THE INVENTION

A flag pole device is provided that is configured to position and secure flags, banners, and the like. In some embodiments, the device may include an elongated pole that may be coupled to a base. The base may have a channel wall coupled to a mounting plate, and the channel wall may include a first channel interior surface forming a first elongated pole channel. The first elongated pole channel may include a first channel axis that extends centrally through the first elongated pole channel. The channel wall may also include a second channel interior surface forming a second elongated pole channel, and the second elongated pole channel may include a second channel axis that extends centrally through the second elongated pole channel. Both the first elongated pole channel and the second elongated pole channel may be configured to receive a first portion of the elongated pole so that the first portion of the elongated pole may be positioned in one of the first elongated pole channel and the second elongated pole channel, and the first channel axis may be angled relative to the second channel axis. The device may include a flag coupler having a retainer and a housing, and the retainer may include a retainer wall having an exterior retainer surface and an opposing interior retainer surface. The retainer may include a retainer channel formed by the interior retainer surface, and the retainer may include a retainer lip and a retainer fastener aperture. The housing may include a housing wall having an exterior housing surface and an opposing interior housing surface, and the housing may include a housing channel formed by the interior housing surface. The housing may include a housing fastener aperture. A fastener ring may be coupled to the flag coupler. The fastener ring may include a major ring aperture, and a flag fastener is coupled to the fastener ring. The fastener ring may be coupled to the flag coupler by inserting the retainer wall of the retainer through the major ring aperture and into the housing channel of the housing so that the fastener ring is positioned between the retainer lip and the housing. The flag coupler may be coupled to the elongated pole by inserting a second portion of the elongated pole through the retainer channel of the retainer wall that is positioned within the housing channel.

In some embodiments, the device may include an elongated pole that may be coupled to a base. The base may have a channel wall and a mounting plate. The mounting plate may include a planar mounting surface, and the channel wall may include a channel interior surface forming an elongated pole channel. The elongated pole channel may include a channel axis that extends centrally through the elongated pole channel, and the elongated pole channel may be configured to receive a first portion of the elongated pole so that the first portion of the elongated pole may be positioned in the elongated pole channel. A first base connector wall, having a first plurality of base teeth and a first pivotal fastener aperture, may be coupled to the mounting plate, and a second base connector wall, having a second plurality of base teeth and a second pivotal fastener aperture, may be coupled to the channel wall. The first base connector wall may be coupled to the second base connector wall via a pivotal fastener that is inserted through the first pivotal fastener aperture and the second pivotal fastener aperture so that the first plurality of base teeth and the second plurality of base teeth contact each other. The elongated pole channel may be movable between a first position, in which the channel axis is substantially perpendicular to the planar mounting surface, and a second position, in which the channel axis is substantially parallel to the planar mounting surface. The device may include a flag coupler having a retainer and a housing, and the retainer may include a retainer wall having an exterior retainer surface and an opposing interior retainer surface. The retainer may include a retainer channel formed by the interior retainer surface, and the retainer may include a retainer lip and a retainer fastener aperture. The housing may include a housing wall having an exterior housing surface and an opposing interior housing surface, and the housing may include a housing channel formed by the interior housing surface. The housing may include a housing fastener aperture. A fastener ring may be coupled to the flag coupler. The fastener ring may include a major ring aperture, and a flag fastener is coupled to the fastener ring. The fastener ring may be coupled to the flag coupler by inserting the retainer wall of the retainer through the major ring aperture and into the housing channel of the housing so that the fastener ring is positioned between the retainer lip and the housing. The flag coupler may be coupled to the elongated pole by inserting a second portion of the elongated pole through the retainer channel of the retainer wall that is positioned within the housing channel.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of a first example of a flag pole device according to various embodiments described herein.

FIG. 2 illustrates a top perspective view of a first example of a base according to various embodiments described herein.

FIG. 3 shows a side elevation view of a first example of a base according to various embodiments described herein.

FIG. 4 depicts a bottom plan view of a first example of a base according to various embodiments described herein.

FIG. 5 illustrates a sectional, through line 5-5 shown in FIG. 4, elevation view of a first example of a base according to various embodiments described herein.

FIG. 6 shows a perspective view of a second example of a flag pole device according to various embodiments described herein.

FIG. 7 depicts a top perspective view of a second example of a base according to various embodiments described herein.

FIG. 8 illustrates a side elevation view of a second example of a base according to various embodiments described herein.

FIG. 9 shows a bottom plan view of a second example of a base according to various embodiments described herein.

FIG. 10 depicts a sectional, through line 10-10 shown in FIG. 9, elevation view of a first second of a base according to various embodiments described herein.

FIG. 11 illustrates a perspective view of a third example of a flag pole device according to various embodiments described herein.

FIG. 12 shows a first side elevation view of a third example of a base in a first position according to various embodiments described herein.

FIG. 13 depicts a second side elevation view of a third example of a base in a second position according to various embodiments described herein.

FIG. 14 illustrates a first side elevation view of some example components of a third example of a mounting plate according to various embodiments described herein.

FIG. 15 shows a sectional, through line 15-15 shown in FIG. 16, elevation view of some example components of a third example of a mounting plate according to various embodiments described herein.

FIG. 16 depicts a top plan view of some example components of a third example of a mounting plate according to various embodiments described herein.

FIG. 17 illustrates a bottom plan view of some example components of a third example of a mounting plate according to various embodiments described herein.

FIG. 18 shows a first side elevation view of some example components of a third example of a channel wall according to various embodiments described herein.

FIG. 19 depicts a sectional, through line 19-19 shown in FIG. 20, elevation view of some example components of a third example of a channel wall according to various embodiments described herein.

FIG. 20 illustrates a second side elevation view of some example components of a third example of a channel wall according to various embodiments described herein.

FIG. 21 shows a side elevation view of an example of an elongated pole according to various embodiments described herein.

FIG. 22 depicts a perspective view of an example of a flag coupler, fastener ring, and flag fastener according to various embodiments described herein.

FIG. 23 illustrates a perspective view of an example of a retainer according to various embodiments described herein.

FIG. 24 shows a plan view of an example of a retainer according to various embodiments described herein.

FIG. 25 depicts a first side elevation view of an example of a retainer according to various embodiments described herein.

FIG. 26 illustrates a second side elevation view of an example of a retainer according to various embodiments described herein.

FIG. 27 shows a third side elevation view of an example of a retainer according to various embodiments described herein.

FIG. 28 depicts a sectional, through line 28-28 shown in FIG. 26, elevation view of an example of a retainer according to various embodiments described herein.

FIG. 29 illustrates a top plan view of an example of a housing according to various embodiments described herein.

FIG. 30 shows a bottom plan view of an example of a housing according to various embodiments described herein.

FIG. 31 depicts a first side elevation view of an example of a housing according to various embodiments described herein.

FIG. 32 illustrates a second side elevation view of an example of a housing according to various embodiments described herein.

FIG. 33 shows a sectional, through line 33-33 shown in FIG. 29, elevation view of an example of a housing according to various embodiments described herein.

FIG. 34 depicts a top perspective view of an example of a fastener ring according to various embodiments described herein.

FIG. 35 illustrates a bottom perspective view of an example of a fastener ring according to various embodiments described herein.

FIG. 36 shows a perspective view of an example of a coupler fastener according to various embodiments described herein.

FIG. 37 depicts a first elevation view of an example of a coupler fastener according to various embodiments described herein.

FIG. 38 illustrates a second elevation view of an example of a coupler fastener according to various embodiments described herein.

FIG. 39 shows a perspective view of an example of a cap according to various embodiments described herein.

FIG. 40 depicts a sectional, through line 40-40 shown in FIG. 39, elevation view of an example of a cap according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

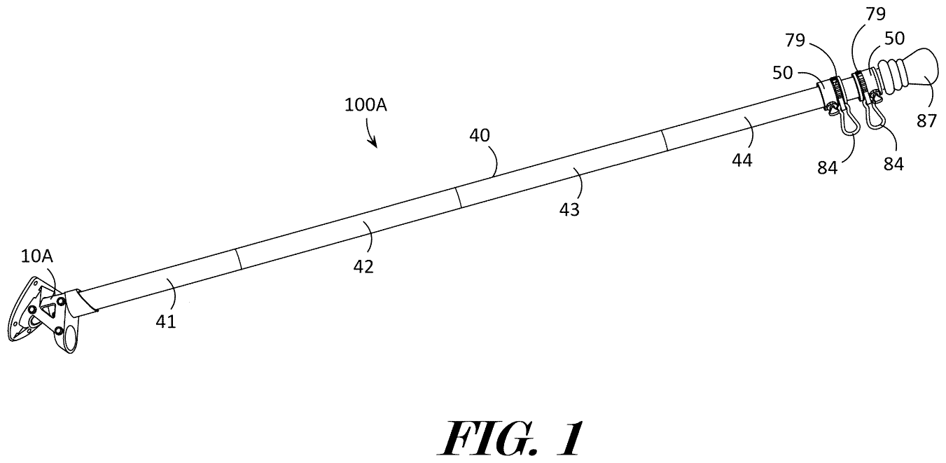

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 20% of the specified number. Additionally, as used in this application, the term “substantially” means that the actual value is within about 10% of the actual desired value, more preferably within about 5% of the actual desired value and even more preferably within about 1% of the actual desired value of any variable, element or limit set forth herein.

A new flag pole device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIGS. 1, 6 and 11 illustrate examples of a flag pole device (“the device”) 100A, 100B, 100C. In some embodiments, the device 100A, 100B, 100C, may comprise one or more bases 10A, 10B, 10C, which may be configured to couple the device 100A, 100B, 100C, to an object or surface. A base 10A, 10B, 10C, may include one or more elongated pole channels 11, 12, which may be sized and shaped to receive a portion of a pole 40 to which a flag, banner, or the like, may be coupled to the device 100 via one or more flag couplers 50 and fastener rings 79.

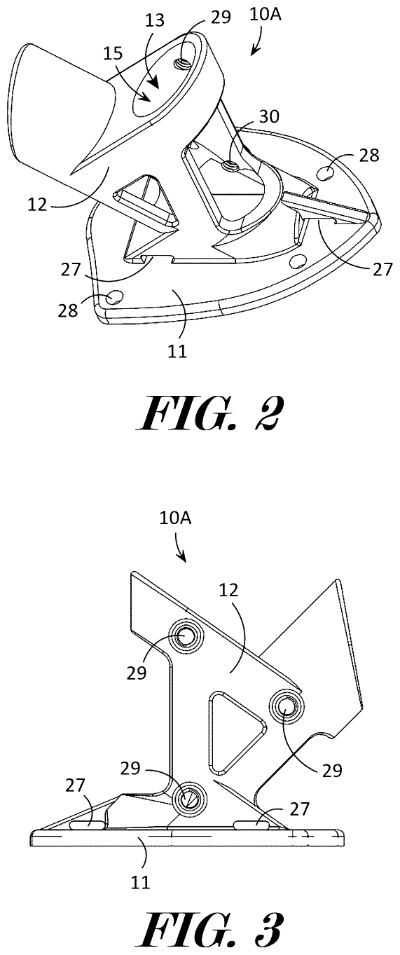

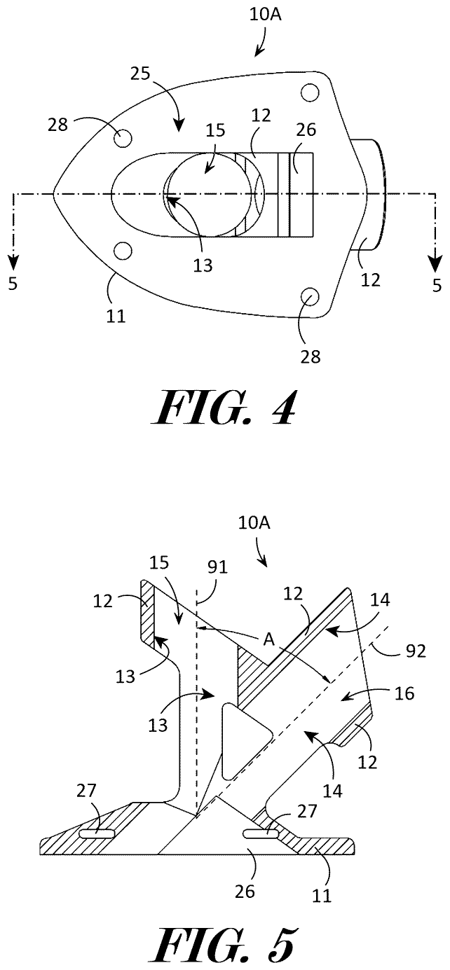

Referring to FIGS. 1-5, in some embodiments, the device 100A may comprise a base 10A having a mounting plate 11 to which a channel wall 12 may be coupled, and the channel wall 12 may extend away from the mounting plate 11. The channel wall 12 may comprise a first channel interior surface 13 and a second channel interior surface 14. The first channel interior surface 13 may form a first elongated pole channel 15, and the second channel interior surface 14 may form a second elongated pole channel 16. The first channel interior surface 13 may be generally cylindrical in shape so as to form a first elongated pole channel 15 that is generally cylindrical in shape. Likewise, second channel interior surface 14 may be generally cylindrical in shape so as to form a second elongated pole channel 16 that is generally cylindrical in shape. In some embodiments, the elongated pole channels 15, 16, may each be sized and shaped to receive a portion of an elongated pole 40 so that an elongated pole 40 may be alternatively positioned in the elongated pole channels 15, 16. In some embodiments, the elongated pole channels 15, 16, may each be sized and shaped so that two poles 40 may be simultaneously positioned in the elongated pole channels 15, 16. The first elongated pole channel 15 may comprise a first channel axis 91 that may extend through the center radius of the first channel interior surface 13 and through the center of the first elongated pole channel 15 so that the first channel axis 91 may be parallel to the generally cylindrical in shape first channel interior surface 13 that surrounds it. The second elongated pole channel 16 may comprise a second channel axis 92 that may extend through the center radius of the second channel interior surface 14 and though the center of the second elongated pole channel 16 so that the second channel axis 92 may be parallel to the generally cylindrical in shape second channel interior surface 14 that surrounds it. The first channel axis 91 may be substantially parallel to the elongated length of an elongated pole 40 that is inserted into the first elongated pole channel 15, and the first channel axis 91 may be substantially bisect the elongated length of an elongated pole 40 that is inserted into the first elongated pole channel 15. The second channel axis 92 may be substantially parallel to the elongated length of an elongated pole 40 that is inserted into the second elongated pole channel 16, and the second channel axis 92 may be substantially bisect the elongated length of an elongated pole 40 that is inserted into the second elongated pole channel 16. Preferably, the first elongated pole channel 15 and the second elongated pole channel 16 may intersect so that the first channel axis 91 and second channel axis 92 may also intersect. In some embodiments, the first channel axis 91 and second channel axis 92 may be angled relative to each other as shown by angle A in FIG. 5, and Angle A may be between 30 and 60 degrees, more preferably between 40 and 50 degrees, and more preferably substantially 45 degrees.

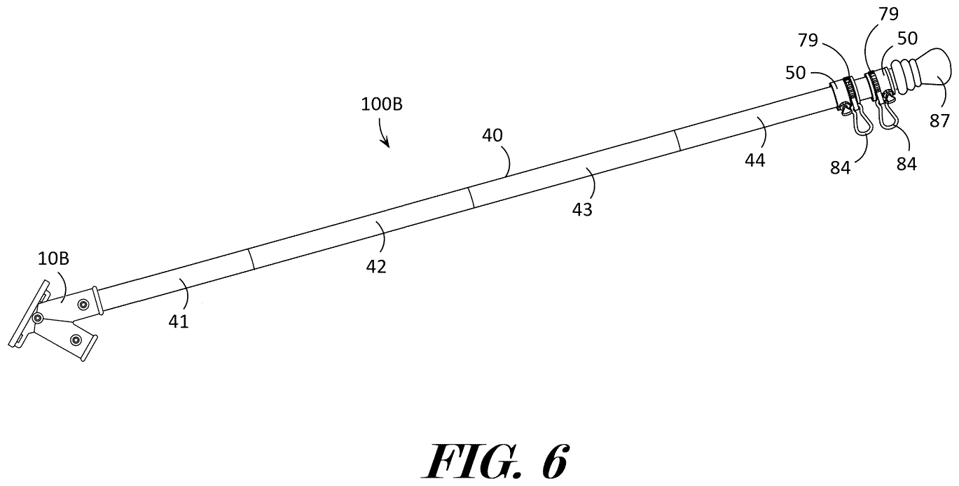

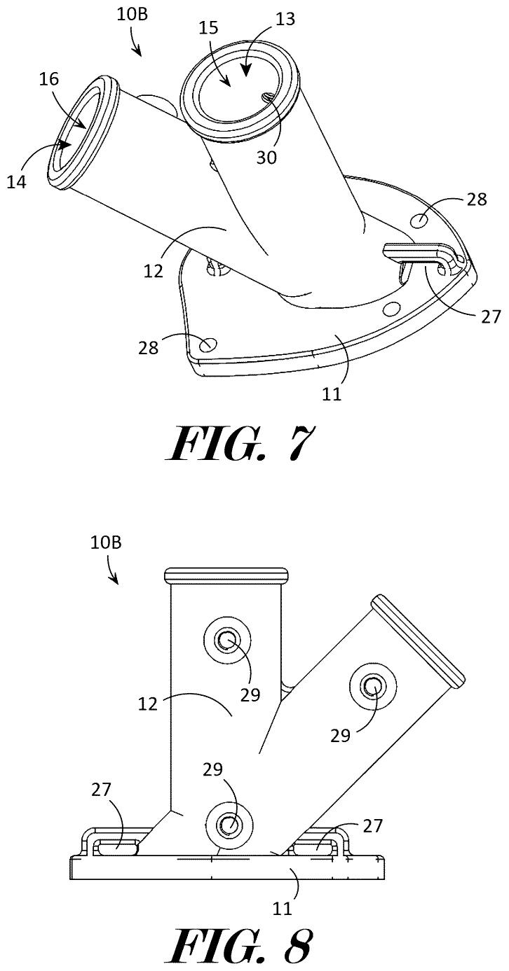

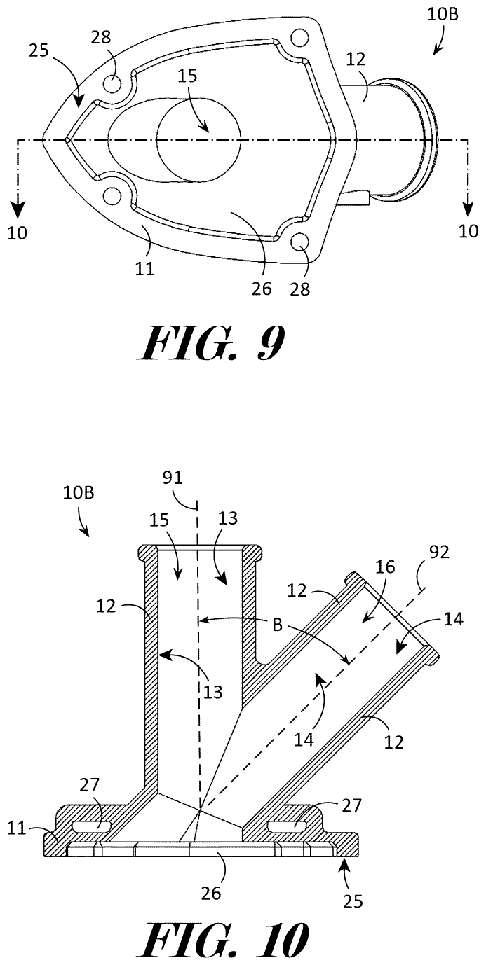

Referring to FIGS. 6-10, in some embodiments, the device 100B may comprise a base 10B having a mounting plate 11 to which a channel wall 12 may be coupled, and the channel wall 12 may extend away from the mounting plate 11. The channel wall 12 may comprise a first channel interior surface 13 and a second channel interior surface 14. The first channel interior surface 13 may form a first elongated pole channel 15, and the second channel interior surface 14 may form a second elongated pole channel 16. The elongated pole channels 15, 16, may each be sized and shaped to receive a portion of an elongated pole 40 so that an elongated pole 40 may be alternatively positioned in the elongated pole channels 15, 16, or so that two poles 40 may be simultaneously positioned in the elongated pole channels 15, 16. The first channel interior surface 13 may be generally cylindrical in shape so as to form a first elongated pole channel 15 that is generally cylindrical in shape. Likewise, second channel interior surface 14 may be generally cylindrical in shape so as to form a second elongated pole channel 16 that is generally cylindrical in shape. The first elongated pole channel 15 may comprise a first channel axis 91 that may extend through the center radius of the first channel interior surface 13 and the first elongated pole channel 15 so that the first channel axis 91 may be parallel to the generally cylindrical in shape first channel interior surface 13 that surrounds it. The second elongated pole channel 16 may comprise a second channel axis 92 that may extend through the center radius of the second channel interior surface 14 and the second elongated pole channel 16 so that the second channel axis 92 may be parallel to the generally cylindrical in shape second channel interior surface 14 that surrounds it. The first channel axis 91 may be substantially parallel to the elongated length of an elongated pole 40 that is inserted into the first elongated pole channel 15, and the first channel axis 91 may be substantially bisect the elongated length of an elongated pole 40 that is inserted into the first elongated pole channel 15. The second channel axis 92 may be substantially parallel to the elongated length of an elongated pole 40 that is inserted into the second elongated pole channel 16, and the second channel axis 92 may be substantially bisect the elongated length of an elongated pole 40 that is inserted into the second elongated pole channel 16. Preferably, the first elongated pole channel 15 and the second elongated pole channel 16 may intersect so that the first channel axis 91 and second channel axis 92 may also intersect. In some embodiments, the first channel axis 91 and second channel axis 92 may be angled relative to each other as shown by angle B in FIG. 9, and Angle B may be between 30 and 60 degrees, more preferably between 40 and 50 degrees, and more preferably substantially 45 degrees.

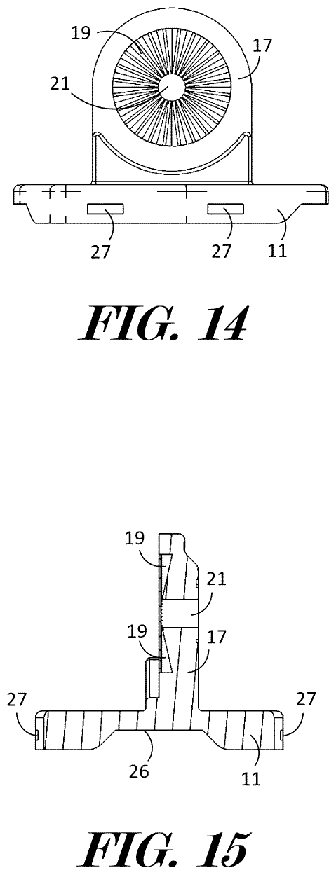

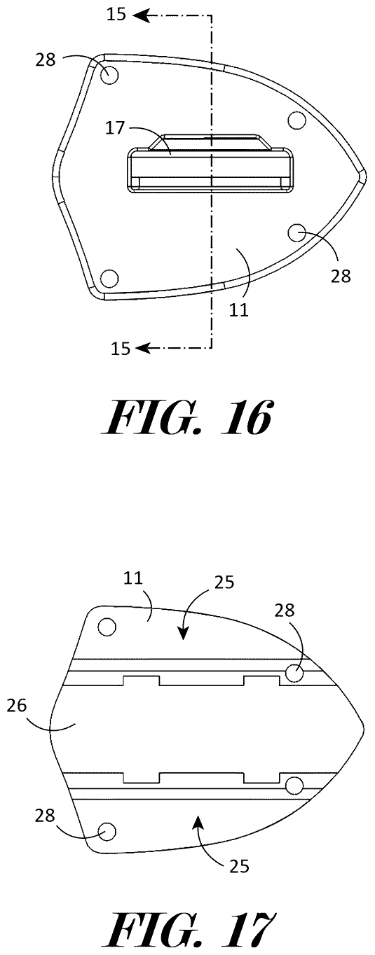

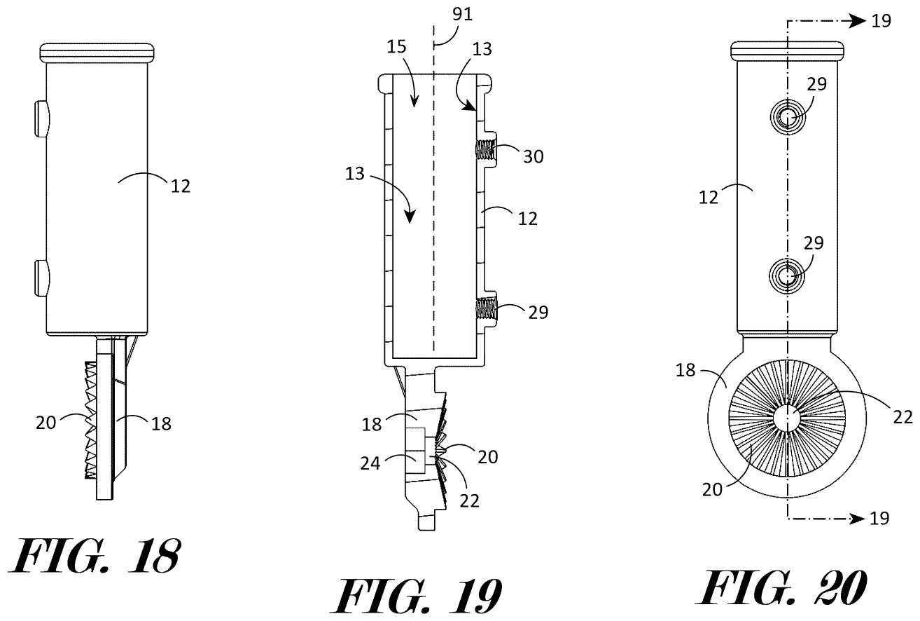

Referring to FIGS. 11-20, in some embodiments, the device 100C may comprise a base 10C having a mounting plate 11 to which a channel wall 12 may be coupled. The channel wall 12 may comprise a first channel interior surface 13, and the first channel interior surface 13 may form a first elongated pole channel 15. The first channel interior surface 13 may be generally cylindrical in shape so as to form a first elongated pole channel 15 that is generally cylindrical in shape. The first elongated pole channel 15 may comprise a first channel axis 91 that may extend through the center radius of the first channel interior surface 13 and the first elongated pole channel 15 so that the first channel axis 91 may be parallel to the generally cylindrical in shape first channel interior surface 13 that surrounds it. The first channel axis 91 may be substantially parallel to the elongated length of an elongated pole 40 that is inserted into the first elongated pole channel 15, and the first channel axis 91 may be substantially bisect the elongated length of an elongated pole 40 that is inserted into the first elongated pole channel 15.

The base 10C may comprise one or more base connector walls, such as a first base connector wall 17 and a second base connector wall 18. A first base connector wall 17 may be coupled to the mounting plate 11, and the first base connector wall 17 may extend away from the mounting plate 11. A second base connector wall 18 may be coupled to the channel wall 12, and the second base connector wall 18 may extend away from the channel wall 12 and its first elongated pole channel 15.

The first base connector wall 17 may comprise a first plurality of base teeth 19 and a first pivotal fastener aperture 21, and the second base connector wall 18 may comprise a second plurality of base teeth 20 and a second pivotal fastener aperture 22. Preferably, the first plurality of base teeth 19 may be elongated and may radiate away from the first pivotal fastener aperture 21. Optionally, the first plurality of base teeth 19 may encircle the first pivotal fastener aperture 21. Preferably, the second plurality of base teeth 20 may be elongated and may radiate away from the second pivotal fastener aperture 22. Optionally, the second plurality of base teeth 20 may encircle the second pivotal fastener aperture 22.

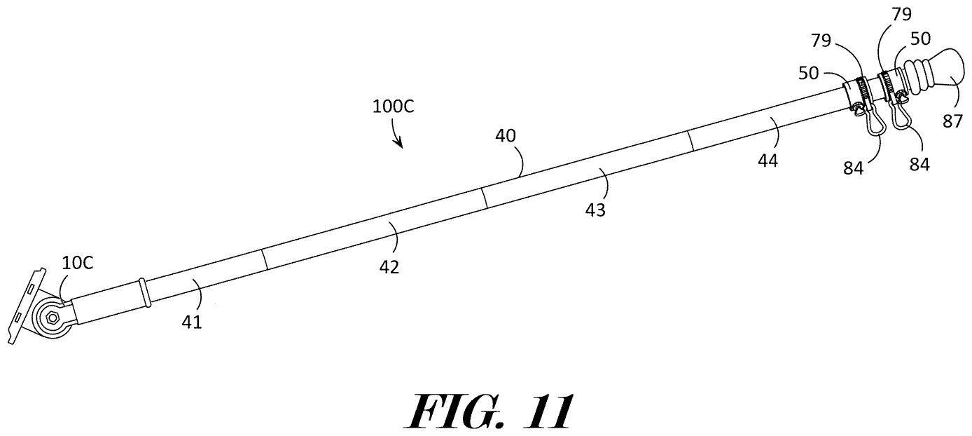

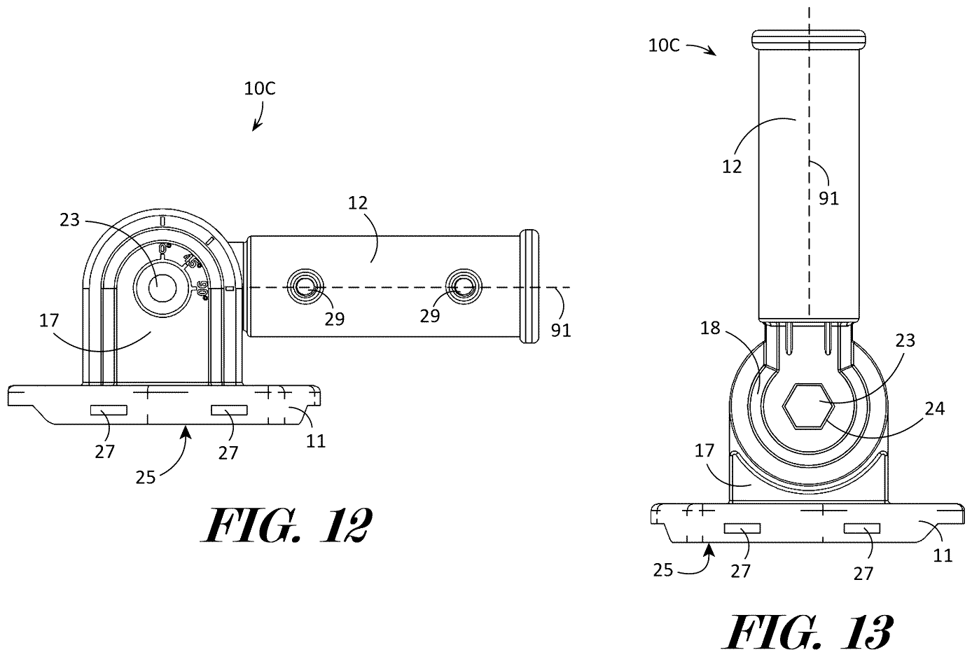

The first base connector wall 17 may be coupled to the second base connector wall 18 via a pivotal fastener 23 that may be inserted through the first pivotal fastener aperture 21 and the second pivotal fastener aperture 22 so that the first plurality of base teeth 19 and the second plurality of base teeth 20 may contact each other. A pivotal fastener 23 may comprise a screw, bolt, pivot pin, rivet, or any other fastener which may pivotally couple two objects together. The positioning of the first elongated pole channel 15 relative to the mounting plate 11 may be selected and changed by selecting which base teeth 19 of the first plurality of base teeth 19 engage with which base teeth 20 of the second plurality of base teeth 20 by loosening and tightening the pivotal fastener 23. For example, the first elongated pole channel 15 may be positioned in a first position in which the first channel axis 91 may be generally perpendicular to the mounting plate 11 (and/or generally perpendicular to a flat or planar in shape mounting surface 25) as perhaps best shown in FIG. 12, and the first elongated pole channel 15 may be positioned in a second position in which the first channel axis 91 may be generally parallel to the mounting plate 11 (and/or generally parallel to a flat or planar in shape mounting surface 25) as perhaps best shown in FIG. 13. As another example, the first elongated pole channel 15 may be positioned in a first position in which the first channel axis 91 may be substantially perpendicular (plus or minus 10 degrees) to the mounting plate 11 (and/or substantially perpendicular (plus or minus 10 degrees) to a flat or planar in shape mounting surface 25) as perhaps best shown in FIG. 12, and the first elongated pole channel 15 may be positioned in a second position in which the first channel axis 91 may be substantially perpendicular (plus or minus 10 degrees) to the mounting plate 11 (and/or substantially perpendicular (plus or minus 10 degrees) to a flat or planar in shape mounting surface 25) as perhaps best shown in FIG. 13. The size and spacing of the first plurality of base teeth 19 and the second plurality of base teeth 20 may dictate how many positions that the first elongated pole channel 15 may be positioned in when the first plurality of base teeth 19 are mated with the second plurality of base teeth 20 by a pivotal fastener 23. In preferred embodiments, the size and spacing of the first plurality of base teeth 19 and the second plurality of base teeth 20 may enable the first elongated pole channel 15 to be positioned in a plurality of positions in an approximately 180 degree arc relative to the mounting plate 11 and its one or more mounting surfaces 25.

Preferably, the base 10C may comprise a fastener lock aperture 24 which a portion of a pivotal fastener 23 may be inserted into prevent the pivotal fastener 23 from rotating relative to the base connector wall 17, 18, that the fastener lock aperture 24 may be disposed in. For example, a second base connector wall 18 may comprise a hexagonal prism shaped fastener lock aperture 24 in communication with a second pivotal fastener aperture 22 and a pivotal fastener 23 may comprise a hexagonal head bolt, and by inserting the hexagonal head of the pivotal fastener 23 hexagonal prism shaped fastener lock aperture 24, the pivotal fastener 23 may be prevented from rotating in the hexagonal prism shaped fastener lock aperture 24 and the second pivotal fastener aperture 22 of the second base connector wall 18.

A base 10A, 10B, 10C, may comprise a channel wall 12 that may be configured in any shape and size. A channel wall 12 may be made from or may comprise a substantially rigid material that is resistant to deformation. Example substantially rigid materials include: steel alloys, aluminum, aluminum alloys, copper alloys, other types of metal or metal alloys, ceramics such as alumina, porcelain, and boron carbide, earthenware, natural stone, synthetic stone, various types of hard plastics, such as polyethylene (PE), Ultra-high-molecular-weight polyethylene (UHMWPE, UHMW), polypropylene (PP) and polyvinyl chloride (PVC), polycarbonate, nylon, Poly (methyl methacrylate) (PMMA) also known as acrylic, melamine, hard rubbers, fiberglass, carbon fiber, resins, such as epoxy resin, wood, other plant based materials, or any other material including combinations of materials that are substantially rigid

A base 10A, 10B, 10C, may comprise one or more elongated pole channels 15, 16, which may each be configured to receive a portion of an elongated pole 40. The channel wall 12 may comprise one or more channel interior surfaces 13, 14, and each channel interior surface 13, 14, may form an elongated pole channel 15, 16. Preferably, channel interior surfaces 13, 14, may be complementary in shape to the shape of an elongated pole 40 that is to be inserted into the elongated pole channel 15, 16, formed by the channel interior surfaces 13, 14. For example, channel interior surfaces 13, 14, may be generally cylindrical in shape so as to form an elongated pole channels 15, 16, that are generally cylindrical in shape to receive a cylindrical shaped portion of an elongated pole 40. As another example, channel interior surfaces 13, 14, may be generally rectangular prism in shape so as to form an elongated pole channels 15, 16, that are generally rectangular prism in shape to receive a rectangular prism shaped portion of an elongated pole 40.

A base 10A, 10B, 10C, may comprise a mounting plate 11 which may form the

portion of the base 10A, 10B, 10C, that is configured to couple the device 100A, 100B, 100C, to an object or surface. A mounting plate 11 may be configured in any size and shape, and a mounting plate 11 may be made from or may comprise a substantially rigid material. A mounting plate 11 may comprise one or more mounting surfaces 25 which may contact an object or surface that the device 100A, 100B, 100C, may be coupled to. A mounting surface 25 may be configured in any size and shape. In preferred embodiments, a mounting surface 25 may be flat or planar in shape. Optionally, a base 10A, 10B, 10C, may comprise one or more mounting depressions 26 that may form recesses or depressions in the mounting plate 11 that are recessed into the base 10A, 10B, 10C below the one or more mounting surfaces 25. In some embodiments, a first elongated pole channel 15 and/or a second elongated pole channel 16 may be in communication with a mounting depression 26.

In some embodiments, a base 10A, 10B, 10C, may comprise one or more passthrough apertures 27. Preferably, a passthrough aperture 27 may comprise an aperture that may extend through a mounting plate 11 and may be disposed on the mounting plate 11 so that the passthrough aperture 27 is above the mounting surface(s) 25 and any mounting depressions 26. A passthrough aperture 27 may enable objects to be tied or otherwise coupled to the mounting plate 11.

In some embodiments, a base 10A, 10B, 10C, may comprise one or more mounting apertures 28 which may extend through the mounting plate 11 in a direction that is generally parallel to the direction that a passthrough aperture 27 may extend through a mounting plate 11. Optionally, a mounting aperture 28 may extend through the mounting plate 11 and through a mounting surface 25 or a mounting depression 26. Mounting apertures 28 may be configured to receive fasteners, such as screws, nails, bolts, rivets, etc., which may be used to couple the base 10A, 10B, 10C, to an object or surface that the device 100A, 100B, 100C, is to be coupled to.

In some embodiments, a base 10A, 10B, 10C, may comprise one or more base fastener apertures 29 which may extend through a channel wall 12 and into communication with an elongated pole channel 15, 16. Base fastener apertures 29 may comprise threading 30 which may mate with and engage with a threaded fastener, such as a bolt, screw, coupler fastener 85, etc. In preferred embodiments, once a portion of an elongated pole 40 is inserted into an elongated pole channel 15, 16, a coupler fastener 85, or other threaded fastener, may be threaded into the threading 30 of a base fastener aperture 29 so that the coupler fastener 85, or other threaded fastener, may contact the portion of the elongated pole 40 is inserted into an elongated pole channel 15, 16, and may be tightened against the elongated pole 40 to secure and couple the elongated pole 40 to the base 10A, 10B, 10C.

The device 100A, 100B, 100C, may comprise an elongated pole 40 which preferably may be coupled to a base 10A, 10B, 10C, one or more flag couplers 50, and a cap 87. An elongated pole 40 may comprise any shape, and preferably an elongated shape, having a length substantially greater than its width and height. In some embodiments, an elongated pole 40 may comprise an elongated cylindrical shape. In other embodiments, an elongated pole 40 may comprise an elongated hexagonal prism shape. In alternative embodiments, an elongated pole 40 may comprise an elongated triangular prism shape, an elongated rectangular prism shape, an elongated oval shape, or any other shape including combinations of shapes.

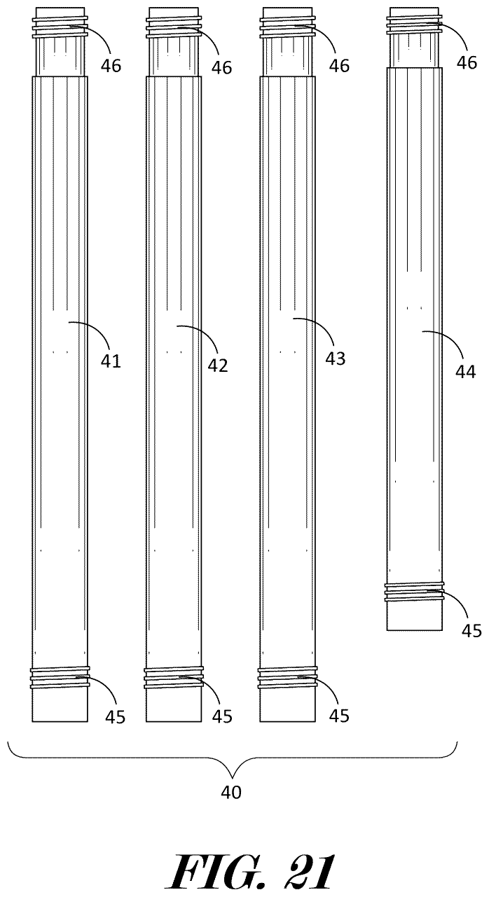

In preferred embodiments, and as perhaps best shown in FIG. 21, the device 100A, 100B, 100C, may comprise an elongated pole 40 that may have one or more pole sections 41, 42, 43, 44, which may be removably coupled together to form an elongated pole 40 having various lengths. For example, by coupling three pole sections 41, 42, 43, 44, together a relatively shorter length elongated pole 40 may be formed than an elongated pole 40 having four or more pole sections 41, 42, 43, 44. In further embodiments, an elongated pole 40 may be made of a unitary configuration.

Preferably, an elongated pole 40 and/or one or more pole sections 41, 42, 43, 44, may comprise one or more threads, such as a major pole threading 45 and a minor pole threading 46, and a major pole threading 45 of a first pole section 41, 42, 43, 44, may be mated with a minor pole threading 46 of a second pole section 41, 42, 43, 44, in order to removably couple the first pole section 41, 42, 43, 44, to the second pole section 41, 42, 43, 44. Optionally, a cap 60 may be removably coupled to an elongated pole 40 and/or one or more pole sections 41, 42, 43, 44, via pole threading 45, 46. In some embodiments, an elongated pole 40 and/or one or more pole sections 41, 42, 43, 44, may be removably coupled to a base 10A, 10B, 10C, via pole threading 45, 46.

A elongated pole 40, and/or one or more pole sections 41, 42, 43, 44, preferably may be made from or may comprise a substantially rigid material, such as aluminum, carbon fiber, steel, other metal alloys, wood and other plant based materials, hard plastics, such as polyethylene (PE), Ultra-high-molecular-weight polyethylene (UHMWPE, UHMW), polypropylene (PP) and polyvinyl chloride (PVC), polycarbonate, nylon, Poly (methyl methacrylate) (PMMA) also known as acrylic, fiberglass, or any other suitable material that is preferably lightweight yet strong enough to support varying degrees of weight.

In some embodiments, the device 100A, 100B, 100C, may comprise one or more flag couplers 50 which may be configured to couple, and more preferably to removably couple a flag, banner, or the like, to an elongated pole 40. In preferred embodiments, the device 100A, 100B, 100C, may comprise two flag couplers 50, so that a first flag coupler 50 may be used to couple an upper portion of a flag, banner, or the like, to an elongated pole 40, and so that a second flag coupler 50 may be used to couple a lower portion of a flag, banner, or the like, to an elongated pole 40.

In preferred embodiments, a flag coupler 50 may comprise a retainer 51 and a housing 65 that may be coupled to a fastener ring 79 having a flag fastener 84.

In some embodiments, a retainer 51 may comprise a retainer wall 52 having an exterior retainer surface 53 and an opposing interior retainer surface 54 that extend between a first end 55 and an opposing second end 56. A generally cylindrical shaped retainer channel 57 may be formed by the interior retainer surface 54, and preferably the retainer wall 52 may be generally cylindrical in shape. The retainer channel 57 may extend between the first end 55 and second end 56. The interior retainer surface 54 and its retainer channel 57 preferably may be cylindrical in shape having a diameter that is slightly larger than the width of the elongated pole 40 and/or one or more pole sections 41, 42, 43, 44, so that the elongated pole 40 and/or one or more pole sections 41, 42, 43, 44, may be disposed in the retainer channel 57 to allow the retainer 50 to slide up and down the length of the elongated pole 40 and/or one or more pole sections 41, 42, 43, 44, that is positioned in the retainer channel 57.

In some embodiments, a retainer lip 58 may be coupled to the exterior retainer surface 53 proximate to the first end 55. One or more, such as a plurality of retainer projections 59 may be coupled to the retainer lip 58, and the retainer projections 59 may extend towards the second end 56 in a direction that is generally parallel to the exterior retainer surface 53. Retainer projections 59 may be configured in any size and shape, such as a half spherical shape or hemi-spherical shape, triangular prism shape, rectangular prism shape, etc. In preferred embodiments, the device 100A, 100B, 100C, may comprise two or more retainer projections 59 that may be spaced equidistantly apart from each other on an annular retainer lip 58.

In some embodiments, a retainer 51 may comprise a retainer fastener aperture 60 that may extend through the retainer wall 52, between the exterior retainer surface 53 and interior retainer surface 54, and into communication with the retainer channel 57. A retainer fastener aperture 60 may be configured in any size and shape, such as cylindrical in shape. Preferably, a retainer fastener aperture 60 may be sized at least slightly larger than the threaded portion 86 of a coupler fastener 85 so that the threaded portion 86 may be inserted through the retainer fastener aperture 60.

In some embodiments, a retainer 51 may comprise one or more retainer recesses 61, 62, 63, which may be formed in the retainer wall 52. Optionally, a retainer recess 61, 62, 63, may extend through the retainer wall 52. Optionally, a retainer recess 61, 62, 63, may be formed in the exterior retainer surface 53 without extending completely through the retainer wall 52. Preferably, the retainer recess(es) 61, 62, 63, may be sized and shaped to receive a housing key 76, 77, 78, of a housing 65 so that the retainer recess(es) 61, 62, 63, may be mated with the housing key(s) 76, 77, 78, (housing keys 76, 77, 78, inserted into the retainer recess(es) 61, 62, 63).

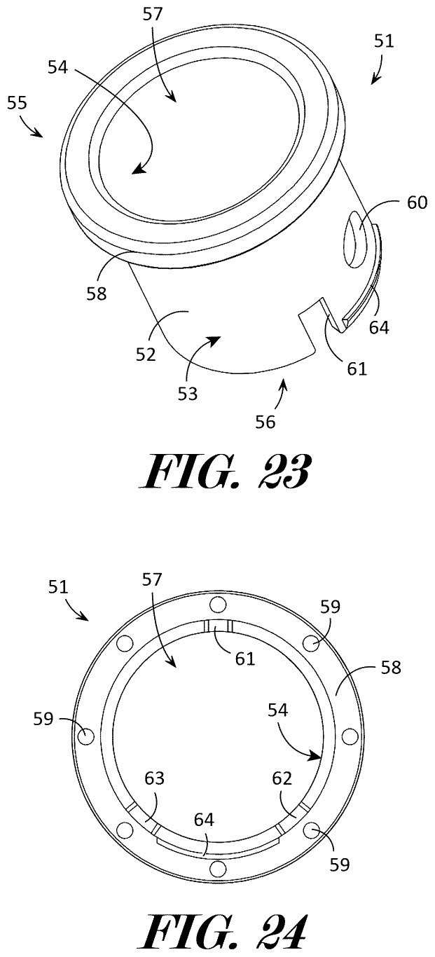

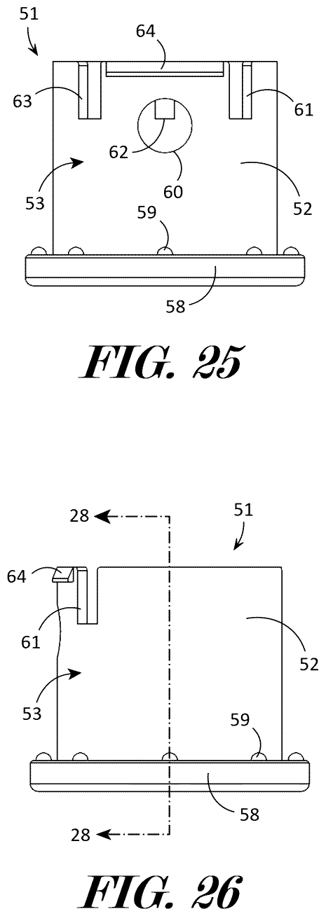

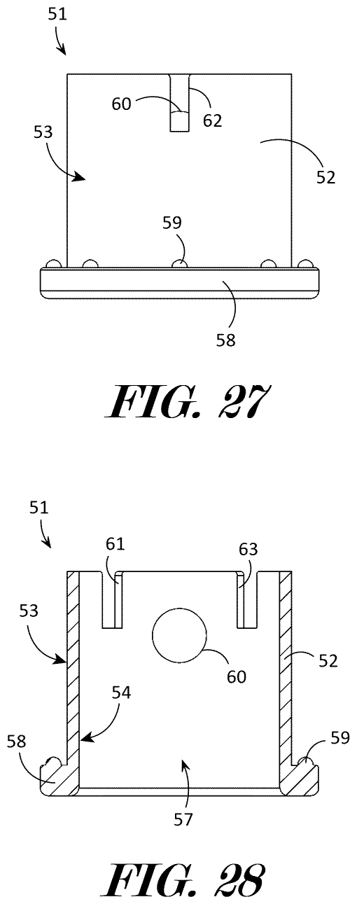

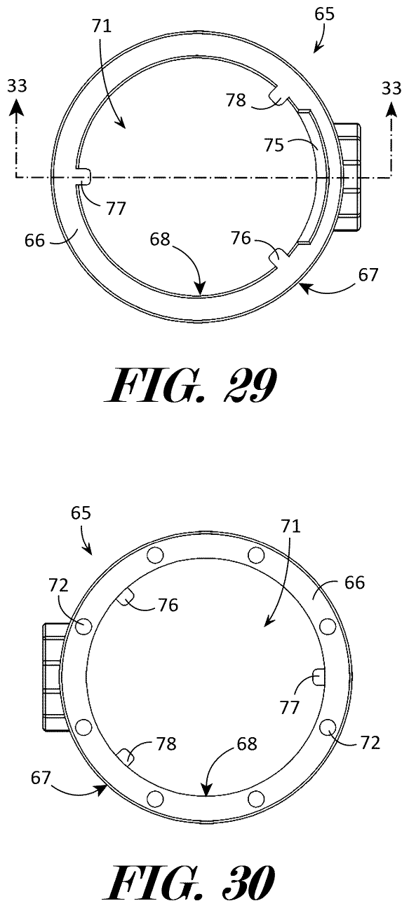

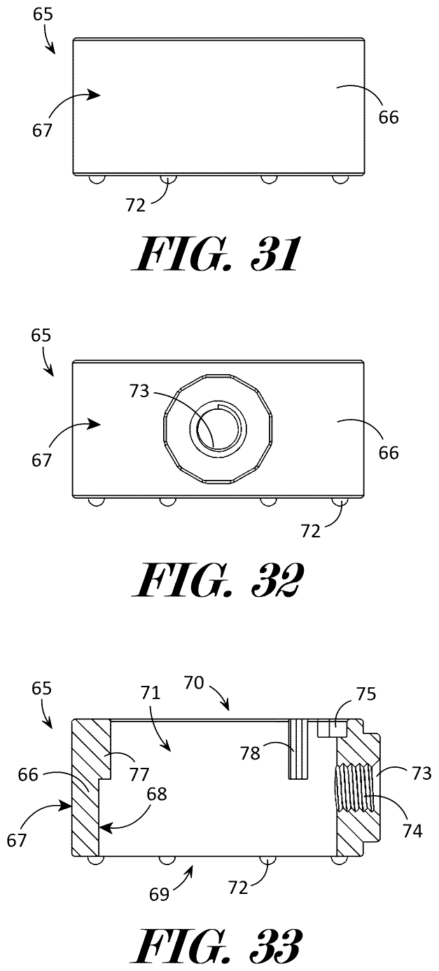

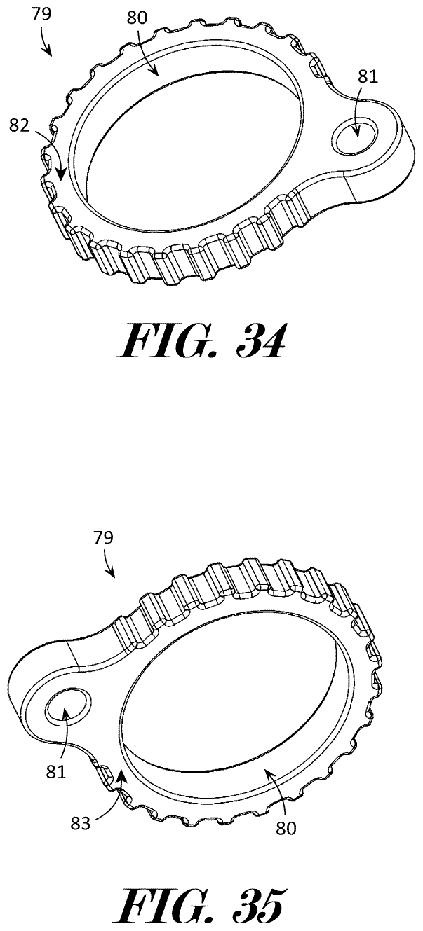

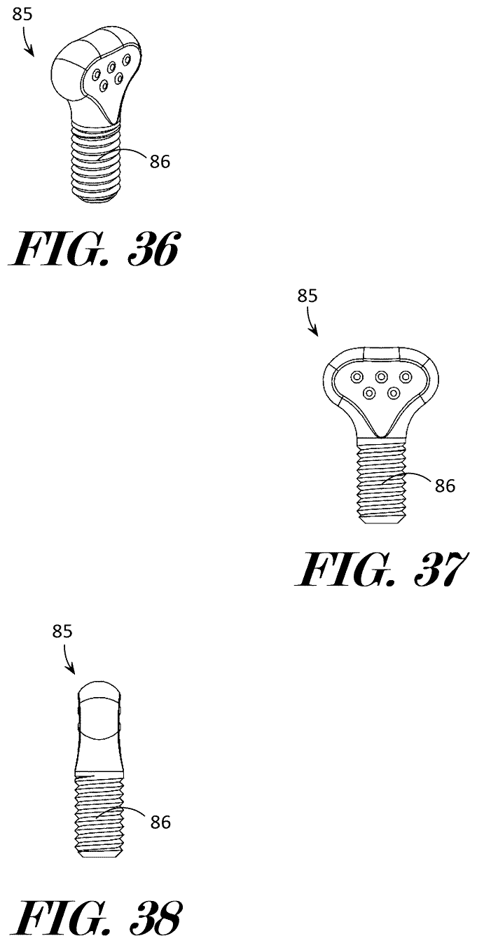

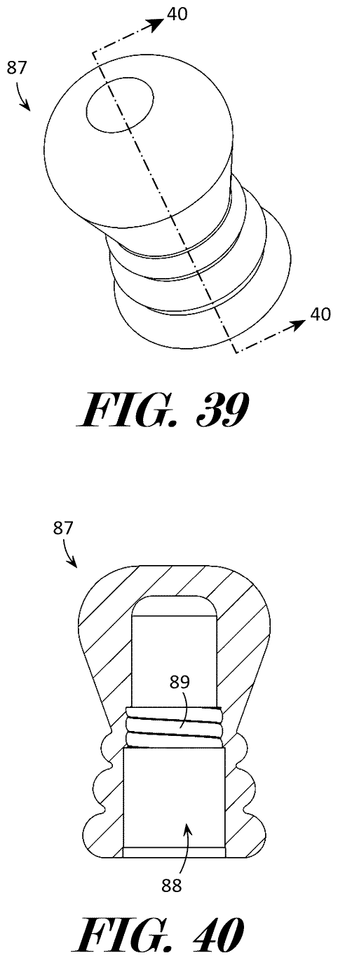

In some embodiments, a retainer 51 may comprise a retainer key 64 which may be coupled to the exterior retainer surface 53 proximate to the second end 56. A retainer key 64 may comprise a projection that may be configured in any size and shape. A retainer key 64 may extend away from the exterior retainer surface 53 and optionally may comprise a barb shape as perhaps best shown in FIGS. 23 and 26.

In some embodiments, a housing 65 may comprise a housing wall 66 having an exterior housing surface 67 and an opposing interior housing surface 68 that extend between a first end 69 and an opposing second end 70. A generally cylindrical shaped housing channel 71 may be formed by the interior housing surface 68, and preferably the housing wall 66 may be generally cylindrical in shape. The housing channel 71 may extend between the first end 69 and second end 70. The interior housing surface 68 and its housing channel 71 preferably may be cylindrical in shape having a diameter that is slightly larger than the width of the exterior retainer surface 53, so that the retainer 51 may be disposed in the housing channel 71, preferably with the exterior retainer surface 53 being placed in contact or proximate to the interior housing surface 68.

In some embodiments, a one or more, such as a plurality of housing projections 72 may be coupled to the first end 69 of the housing wall 66, and the housing projections 72 may extend away from the first end 69 of the housing wall 66 in a direction that is generally parallel to the exterior housing surface 67. Housing projections 72 may be configured in any size and shape, such as a half spherical shape or hemi-spherical shape, triangular prism shape, rectangular prism shape, etc. In preferred embodiments, the device 100A, 100B, 100C, may comprise two or more housing projections 72 that may be spaced equidistantly apart from each other on the first end 69 of the housing wall 66.

In some embodiments, a housing 65 may comprise a housing fastener aperture 73 that may extend through the housing wall 66, between the exterior housing surface 67 and interior housing surface 68, and into communication with the housing channel 71. A housing fastener aperture 73 may be configured in any size and shape, such as cylindrical in shape. Housing fastener apertures 73 may comprise threading 74 which may mate with and engage with a threaded fastener, such as a bolt, screw, coupler fastener 85, etc. In preferred embodiments, once a retainer 51 is inserted into the housing channel 71 and a portion of an elongated pole 40 is inserted into the retainer channel 57, a coupler fastener 85, or other threaded fastener, may be threaded into the threading 74 of the housing fastener aperture 73 and through the retainer retainer's 51 fastener aperture 60 so that the coupler fastener 85, or other threaded fastener, may contact the portion of the elongated pole 40 inserted into the retainer channel 57, and may be tightened against the elongated pole 40 to secure and couple the elongated pole 40 and flag coupler 50 together so that the flag coupler 50 may not be moved relative to the elongated pole 40. By loosening the coupler fastener 85 from being tightened against the elongated pole 40, the flag coupler 50 may then be moved to a desired position on the elongated pole 40 and then the coupler fastener 85 may be re-tightened against the elongated pole 40 so that the flag coupler 50 may not be moved relative to the elongated pole 40. In this manner a flag coupler 50 may be movably and removably coupled to the elongated pole 40 and may be repositionable on the elongated pole 40.

In some embodiments, a housing 65 may comprise a housing recess 75 which may be formed in the housing wall 66, preferably proximate to or in contact with the second end 70. Optionally, a housing recess 75 may be formed in the interior housing surface 68 without extending completely through the housing wall 66. Preferably, the housing recess 75 may be sized and shaped to receive a retainer key 64 of a retainer 51 so that the housing recess 75 may be mated with the retainer key 64 (retainer key 64 inserted into housing recess 75). A housing recess 75 may be sized and shaped slightly larger than a retainer key 64 of a retainer 51 so that once the housing recess 75 is mated with the retainer key 64, the housing recess 75 and the retainer key 64 may align the retainer fastener aperture 60 and housing fastener aperture 73 with each other so that a coupler fastener 85 may be inserted through both the retainer fastener aperture 60 and housing fastener aperture 73.

In some embodiments, a housing 65 may comprise one or more housing keys 76, 77, 78, which may be coupled to the interior housing surface 68, preferably proximate to or in contact with the second end 70. A housing key 76, 77, 78, may comprise a projection that may be configured in any size and shape. A housing key 76, 77, 78, may extend away from the interior housing surface 68 and into the housing channel 71. A housing key 76, 77, 78, may be sized and shaped slightly larger than a retainer recess 61, 62, 63, of a retainer 51 so that once a housing key 76, 77, 78, is mated with a retainer recess 61, 62, 63, the housing key(s) 76, 77, 78, and the retainer recess(s) 61, 62, 63, may align the retainer fastener aperture 60 and housing fastener aperture 73 with each other so that a coupler fastener 85 may be inserted through both the retainer fastener aperture 60 and housing fastener aperture 73.

In some embodiments, the device 100A, 100B, 100C, may comprise a fastener ring 79 which may be configured to couple, and more preferably to movably couple, a flag fastener 84 to a retainer 51 and a housing 65 that are mated together (the retainer wall 52 is inserted into the housing channel 71 so that the retainer fastener aperture 60 and housing fastener aperture 73 are aligned with each other to receive a coupler fastener 85).

In some embodiments, a fastener ring 79 may comprise a major ring aperture 80 and/or a minor ring aperture 81. The fastener ring 79 may also comprise a first ring surface 82 and a second ring surface 83 that may be positioned on opposite sides of the fastener ring 79 and through which one or both of the major ring aperture 80 and minor ring aperture 81 may extend through.

A major ring aperture 80 may be configured in any size and shape. Preferably, a major ring aperture 80 may be generally circular or cylindrical in shape. A major ring aperture 80 may be sized slightly larger than the exterior retainer surface 53 of the retainer 51 so that the exterior retainer surface 53 may be inserted through the major ring aperture 80. Preferably, the major ring aperture 80 may be sized so that once the exterior retainer surface 53 is inserted through the major ring aperture 80 and the retainer 51 and housing 65 are mated together, the fastener ring 79 may be positioned between, and more preferably gripped between, the retainer projections 59 and the housing projections 72 so that the projections 59, 72, may contact the ring surfaces 82, 83. In preferred embodiments, the projections 59, 72, may contact the ring surfaces 82, 83 to provide the fastener ring 79 with fixed positioning between the retainer 51 and housing 65 to provide and enhance the smooth movement of the fastener ring 79 when the fastener ring 79 is turned or rotated (relative to the retainer 51) either way around the exterior retainer surface 53 of the retainer 51. Generally, projections 59, 72, may smooth the movement of a fastener ring 79 that is movably coupled to the retainer 51 and housing 65.

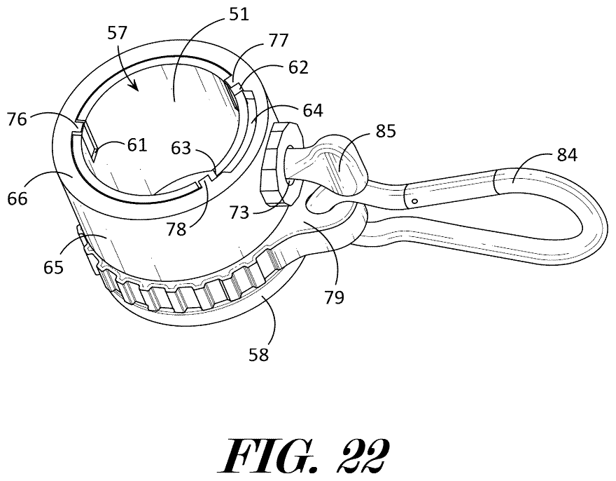

A minor ring aperture 81 may be configured in any size and shape. Preferably, a minor ring aperture 81 may be generally circular or cylindrical in shape. A minor ring aperture 81 may be sized and shaped to be coupled to a flag fastener 84. Preferably, a flag fastener 84 may be coupled to a minor ring aperture 81 by inserting a portion of the flag fastener 84 into the minor ring aperture 81. In preferred embodiments, a flag fastener 84 may comprise a snap hook as perhaps best shown in FIG. 22. Snap hooks, often called spring snap links or spring snap hooks, are self-closing/self-locking connectors with a gate that “opens” into the throat of the hook. The gate is secured with a pin that springs back into place when released to provide a quick connection for rigging, coupling, or anchoring. In other embodiments, a flag fastener 84 may comprise any other device or method for coupling a flag, banner, or the like (such as by coupling a grommet of the flag, banner, or the like) to a fastener ring 79.

In some embodiments, the device 100A, 100B, 100C, may comprise one or more coupler fasteners 85 which may be used to couple, and more preferably to removably couple, an elongated pole 40 to a base 10A, 10B, 10C, and/or to couple, and more preferably to removably couple, a flag coupler 50 to an elongated pole 40. In preferred embodiments, a coupler fastener 85 may comprise a threaded portion 86 which may have threading that is able to engage with the threading 30 of a base fastener aperture 29 and/or a coupler fastener 85 may comprise a threaded portion 86 which may have threading that is able to engage with the threading 74 of a housing fastener aperture 73. By engaging the threaded portion 86 with the threading 30 of a base fastener aperture 29 and into contact with an elongated pole 40 in a first elongated pole channel 15 or second elongated pole channel 16, the coupler fastener 85 may couple the elongated pole 40 and base 10A, 10B, 10C, together. Similarly, by engaging the threaded portion 86 with the threading 74 of a housing fastener aperture 73 and into contact with an elongated pole 40 in a housing channel 71 of a flag coupler 50, the coupler fastener 85 may couple the elongated pole 40 and a flag coupler 50, together.

In some embodiments, the device 100A, 100B, 100C, may comprise a cap 87 which may be coupled to an end of the elongated pole 40 that is distal to the end of the elongated pole 40 that may be coupled to a base 10A, 10B, 10C. A cap 87 may be decorative and/or a cap 87 may be configured to cover an end of the elongated pole 40 to keep water, dirt, and debris out of a hollow elongated pole 40. In preferred embodiments, a cap 87 may comprise a cap channel 88 which may extend into the cap 87 and which may be sized and shaped to receive an end of the elongated pole 40. Preferably, the cap 87 may comprise cap threading 89 which may be disposed in the cap channel 88 and which may be removably coupled to pole threading 45, 46, of an elongated pole 40 to removably couple the cap 87 to the pole 40 via engagement of the cap threading 89 and a pole threading 45, 46.

While some exemplary shapes and sizes have been provided for elements of the device 100A, 100B, 100C, it should be understood to one of ordinary skill in the art that the base 10A, 10B, 10C, pole 40, flag coupler 50, fastener ring 79, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100A, 100B, 100C, may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100A, 100B, 100C, may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100A, 100B, 100C, may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100A, 100B, 100C, may be coupled by being one of connected to and integrally formed with another element of the device 100A, 100B, 100C.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A flag pole device, the device comprising:
an elongated pole;
a base having a channel wall coupled to a mounting plate, wherein the channel wall comprises a first channel interior surface forming a first elongated pole channel, wherein the first elongated pole channel comprise a first channel axis that extends centrally through the first elongated pole channel, wherein the channel wall comprises a second channel interior surface forming a second elongated pole channel, wherein the second elongated pole channel comprise a second channel axis that extends centrally through the second elongated pole channel, wherein both the first elongated pole channel and the second elongated pole channel are configured to receive a first portion of the elongated pole so that the first portion of the elongated pole may be positioned in one of the first elongated pole channel and the second elongated pole channel, and wherein the first channel axis is angled relative to the second channel axis;
a flag coupler having a retainer and a housing, wherein the retainer comprises a retainer wall having an exterior retainer surface and an opposing interior retainer surface, wherein the retainer comprises a retainer channel formed by the interior retainer surface, wherein the retainer comprises a retainer lip and a retainer fastener aperture, wherein the housing comprises a housing wall having an exterior housing surface and an opposing interior housing surface, wherein the housing comprises a housing channel formed by the interior housing surface, and wherein the housing comprises a housing fastener aperture; and
a fastener ring comprising a major ring aperture, wherein a flag fastener is coupled to the fastener ring, wherein the fastener ring is coupled to the flag coupler by inserting the retainer wall of the retainer through the major ring aperture and into the housing channel of the housing so that the fastener ring is positioned between the retainer lip and the housing, and wherein the flag coupler is coupled to the elongated pole by inserting a second portion of the elongated pole through the retainer channel of the retainer wall that is positioned within the housing channel.

2. The device of claim 1, wherein the first channel axis is angled between 30 and 60 degrees relative to the second channel axis.

3. The device of claim 1, wherein the base comprises a passthrough aperture.

4. The device of claim 1, wherein the base comprises a mounting surface and a mounting depression, and wherein the mounting depression is recessed into the base below the mounting surface.

5. The device of claim 1, wherein the base comprises a base fastener aperture that extends through the channel wall.

6. The device of claim 1, wherein the pole comprises a plurality of pole sections.

7. The device of claim 1, wherein the flag coupler is a snap hook.

8. The device of claim 1, wherein the retainer comprises a plurality of retainer projections and the housing comprises a plurality of housing projections, and wherein the retainer projections and the housing projections contact the fastener ring when the fastener ring is coupled to the flag coupler.

9. The device of claim 1, wherein the retainer comprises a retainer recess and the housing comprises a housing key, wherein when the retainer wall of the retainer is inserted into the housing channel of the housing, the retainer recess and housing key are mated together.

10. The device of claim 1, wherein the retainer comprises a retainer key and the housing comprises a housing recess, wherein when the retainer wall of the retainer is inserted into the housing channel of the housing, the retainer key and housing recess are mated together.

11. A flag pole device, the device comprising:
an elongated pole;
a base having a channel wall and a mounting plate, wherein the mounting plate comprises a planar mounting surface, wherein the channel wall comprises a channel interior surface forming an elongated pole channel, wherein the elongated pole channel comprises a channel axis that extends centrally through the elongated pole channel, wherein the elongated pole channel is configured to receive a first portion of the elongated pole so that the first portion of the elongated pole may be positioned in the elongated pole channel, wherein a first base connector wall, having a first plurality of base teeth and a first pivotal fastener aperture, is coupled to the mounting plate, wherein a second base connector wall, having a second plurality of base teeth and a second pivotal fastener aperture, is coupled to the channel wall, wherein the first base connector wall is coupled to the second base connector wall via a pivotal fastener that is inserted through the first pivotal fastener aperture and the second pivotal fastener aperture so that the first plurality of base teeth and the second plurality of base teeth contact each other, and wherein the elongated pole channel is movable between a first position, in which the channel axis is substantially perpendicular to the planar mounting surface, and a second position, in which the channel axis is substantially parallel to the planar mounting surface;
a flag coupler having a retainer and a housing, wherein the retainer comprises a retainer wall having an exterior retainer surface and an opposing interior retainer surface, wherein the retainer comprises a retainer channel formed by the interior retainer surface, wherein the retainer comprises a retainer lip and a retainer fastener aperture, wherein the housing comprises a housing wall having an exterior housing surface and an opposing interior housing surface, wherein the housing comprises a housing channel formed by the interior housing surface, and wherein the housing comprises a housing fastener aperture; and
a fastener ring comprising a major ring aperture, wherein a flag fastener is coupled to the fastener ring, wherein the fastener ring is coupled to the flag coupler by inserting the retainer wall of the retainer through the major ring aperture and into the housing channel of the housing so that the fastener ring is positioned between the retainer lip and the housing, and wherein the flag coupler is coupled to the elongated pole by inserting a second portion of the elongated pole through the retainer channel of the retainer wall that is positioned within the housing channel.

12. The device of claim 11, wherein the base comprises a passthrough aperture.

13. The device of claim 11, wherein the base comprises a mounting surface and a mounting depression, and wherein the mounting depression is recessed into the base below the mounting surface.

14. The device of claim 11, wherein the base comprises a base fastener aperture that extends through the channel wall.

15. The device of claim 11, wherein the pole comprises a plurality of pole sections.

16. The device of claim 11, wherein the flag coupler is a snap hook.

17. The device of claim 11, wherein the retainer comprises a plurality of retainer projections and the housing comprises a plurality of housing projections, and wherein the retainer projections and the housing projections contact the fastener ring when the fastener ring is coupled to the flag coupler.

18. The device of claim 11, wherein the retainer comprises a retainer recess and the housing comprises a housing key, wherein when the retainer wall of the retainer is inserted into the housing channel of the housing, the retainer recess and housing key are mated together.

19. The device of claim 11, wherein the retainer comprises a retainer key and the housing comprises a housing recess, wherein when the retainer wall of the retainer is inserted into the housing channel of the housing, the retainer key and housing recess are mated together.

20. The device of claim 11, further comprising a cap having cap threading, wherein the pole comprises pole threading, and wherein the cap is removably coupled to the pole via engagement of the cap threading and pole threading.
